(19) United States
(12) Patent Application Publication
(10) Pub. No.: US 2011/0238561 A1
(43) Pub. Date: Sep. 29, 2011

(54) Pharmaceutical Derivative Financial Products

(76) Inventors: Bradford Charles Sippy, Acton, MA (US); Lisa Marie Sippy, Acton, MA (US)

(21) Appl. No.: 13/153,421

(22) Filed: Jun. 4, 2011

Related U.S. Application Data
(63) Continuation of application No. 10/358,647, filed on Feb. 5, 2003.

(51) Int. Cl. G06Q 40/00

(52) U.S. Cl. 705/37

(57) ABSTRACT

The present invention describes the creation of derivative financial products such as options, futures, and other derivatives whereby the underlying asset of the derivative is based on a performance indicator, such as prescription volume or prescription market share, of one or more pharmaceutical product(s).

### CROSS-REFERENCE TO RELATED APPLICATIONS

This is a continuation of pending application Ser. No. 10/358,647 filed 5 Feb. 2003.

### COPYRIGHT NOTICE

This document contains material that is subject to copyright protection. The applicant has no objection to the facsimile reproduction of this patent document, as it appears in the U.S. Patent and Trademark Office (PTO) patent file or records or in any publication by the PTO or counterpart foreign or international instrumentalities. The applicant otherwise reserves all copyright rights whatsoever.

### BACKGROUND OF INVENTION

1. Field of the Invention

The present invention relates to the creation of derivative financial products, such as futures and options, based on performance indicators of pharmaceutical products, such as total prescriptions (TRx) or new prescriptions (NRx).

2. Description of Related Art

An important class of financial products is known as derivative securities. Generally speaking, derivative securities are securities whose value is “derived from” the value of other securities. Because of this derived value, derivative securities have become a valuable product with which to transfer risk, allowing for both hedging of risk and speculations. Common examples of derivative securities are futures and options. An option is generally used to hedge risk by providing the right to purchase or sell a commodity or other asset at a later time at a set price with only limited obligations. An option is similar to an insurance policy in that it insures that an asset may be purchased or sold at a later time at a set price in return for a premium, often referred to as an option premium, which is generally a relatively small percentage of the current value of the asset. A first type of option, referred to as a “call” option in the securities market, gives the purchaser of the option the right, but not the obligation, to buy a particular asset at a later time at a guaranteed price, often referred to as the “exercise price.” A second type of option, referred to as a “put” option in the securities market, gives the purchaser of the option the right, but not the obligation, to sell a particular asset at a later time at the exercise price. (The put option may be thought of as giving the owner the right to put the security into another's name at the exercise price.) In either instance, the seller of the call or put option, the option writer, is obligated to perform the associated transactions if the purchaser chooses to exercise its option. The purchase price of an option is known as the option premium. It represents the compensation the purchaser of the options pays to the seller for the right (if profitable to do so) to exercise the option.

For many years, options have been utilized in a variety of asset-based transactions. For example, in the commodities market, commodity producers (e.g., farmers) often enter into option relationships with commodity users (e.g., manufacturers) and speculators; in the real estate market, real estate owners often enter into option relationships with real estate purchasers; and in the securities market, security holders often enter into option relationships with security purchasers.

In an illustrative example for the commodities market, a commodity user (e.g., a cereal manufacturer) which expects that it will need a certain amount of particular commodities (e.g., corn and wheat) at a later time (e.g., in six months), may purchase a call option from a speculator. Conversely, the speculator receives the option premium in return for obligating itself to obtain and sell the set amount of corn and wheat at the exercise price six months from the time the option was granted.

Accordingly, if the price of these commodities increases over the six month period, then the cereal manufacturer will likely exercise the call option and obtain the set amount of commodities from the seller at the guaranteed exercise price. Therefore, by paying the option premium in advance of knowing the actual value of the commodities six months later, the cereal manufacturer may save itself a substantial amount of money, especially if the price of corn or wheat has substantially increased over the six month period due to a number of reasons (e.g., bad weather). Of course, if the price of these commodities does not reach the exercise price over the six month period, then the cereal manufacturer simply will not exercise its option and will purchase the commodities on the open market at the then going price.

On the other hand, farmers who plant their fields many months in advance of having a commodity ready for delivery and wish to guarantee themselves a set price for their commodity at a time in the future may purchase a “put” option from a speculator. Here, if the price (value) of the farmer's commodities goes down over the set period of time for a variety of reasons (e.g., exceptionally good crops yields), in return for the option premium, the farmer is guaranteed that he will receive a set amount of minimum income for his efforts from the speculator.

Futures contracts, similar to options, call for the delivery of an asset or its cash value on a specific date for an agreed-upon price. The long position of the future is held by the party who commits to purchasing the underlying asset on the agreed-upon delivery date. Conversely, the short position of the future is held by the party who commits to delivering the underlying asset on the agreed-upon delivery date. The trader who takes the long position is said to be “buying” the future while the trader who takes the short position is said to be “selling” the future. Since a commitment to carry through on the future contract exists for both buyers and sellers, no price premium is involved in futures and, therefore, no money changes hands at the time of purchase/sale.

A right to purchase an asset at an agreed upon price, versus the obligation to purchase on asset at an agreed upon price, differentiates a call option on a particular asset from the long position of a future on the same asset. The long position of a future obliges the holder to purchase the underlying asset while a call option on the same asset provides the right, at the holder's discretion, to purchase the underlying asset.

Options and futures are traded on a variety of exchanges and are based on a variety of underlying assets such as common stocks, currency exchange rates, commodities, precious metals, and interest rates. As the level of use and sophistication of financial derivatives in the securities markets has increased, new forms of options and futures have been introduced based on intangible underlying assets. An example of these types of financial products are index options, in which the option is based on a stock market index such as the Nasdaq 100 or Russell 2000. Even though options and futures on tangible assets are almost always closed out for a cash settlement prior to expiration, the underlying asset of these financial products is an asset that can be delivered upon expiration. In contrast, options and futures based on market indices do not, and for practical purposes cannot, require the “delivery” of an index when one is exercised. Instead, a cash settlement procedure occurs whereby the value of the option or future (the difference between the exercise price of the option or future and the value of the index multiplied by the number of index units each option or future represents) is directly paid to the exercising party.

A wide variety of different structures exist regarding the way in which an option's exercise price and time of expiration are related to its underlying asset. Below are descriptions of several different option variations.

American versus European Options: An American option is an option structured to allow the holder of the option to exercise the right of purchase (in the case of a call) or sale (in the case of a put) at any time up to and including the expiration date. In contrast, European style options allow for the option holder to exercise the option only on the expiration date. Since the American option provides much greater flexibility, it is assumed to be more valuable than a European option for the same underlying asset, exercise price, and expiration date. However, more sophisticated analyses of this issue have shown that, at least in the case of standardized call options being traded on a formal exchange (and in the absence of trading costs), it is better to trade an American option than exercise it. See e.g., Z. Bodie, et al. Investments (1996), pp. 652-656. Therefore, only on the expiration date does it make sense to actual exercise an American option. Thus, in practice, the two forms of options are managed very similarly. Most options traded in the U.S. are structured as American options, though exceptions do exist (most notably stock index options traded on the Chicago Board of Option Exchange).

Asian Options: Asian options are options whose value depends on the average price of the underlying asset during at least some portion of the life of the option. For example, an Asian put option may have a settlement equal to the strike price minus the average stock price over the last 3 months, if that is positive, and zero otherwise. These options may be of interest to traders wishing to hedge a profit stream that depends on the average price of a commodity over some period of time.

Barrier options: Barrier options are options whose value depends not only on some underlying asset price at option expiration, but also on whether the underlying asset price has crossed through some “barrier.” For example, a down-and-out option is one type of barrier option that automatically expires worthless if and when the stock price falls below some barrier price. Similarly, down-and-in options will not provide a payoff unless the stock price does fall below some barrier at least once during the life of the option. These options are also referred to as knock-out or knock-in options.

Lookback Options: Lookback options are options whose value depends, in part, on the minimum or maximum price of the underlying asset during the life of the option. For example, a lookback put option might provide a settlement equal to the exercise price minus the minimum stock price during the life of the option, instead of the exercise price minus the closing stock price. Such an option provides a form of perfect market timing, providing the put holder with a payoff equal to the one that would accrue were shorted and the short sale was covered at what turns out to be the lowest price during a particular period.

Currency-translated options: Currency-translated options have either underlying asset or exercise prices denominated in a foreign currency. An example of such an option would be one which allows an investor to fix in advance the exchange rate at which an settlement of the option (denominated in a foreign currency) can be converted back into dollars. The right to translate a fixed amount of foreign currency into dollars at a given exchange rate is nothing more than a foreign exchange option. Currency-translated options are more interesting, however, because the amount of currency that will be translated into dollars depends on the investment performance of the underlying asset. Therefore, a currency-translated option provides a random number of foreign exchange options.

Binary Options: Binary, or bet, are options whose with a boolean value structure whereby the value is either a fixed amount or zero, depending on whether a condition is satisfied by the price of the underlying asset. For example, a binary put option might pay off a fixed amount of $100 if the stock price at maturity is below the exercise price.

Futures Options: Futures Options are effectively the combination of two derivatives into one. The Future Options gives the option holder the right to purchase a futures contract at some point in the future for a specific price. In effect, the exercise price of the option is the future price that may be entered into. In cash settlement of the future option, the option holder gets a net payoff equal to the difference between the current futures price on the underlying asset and the exercise price of the option. For example, if a current holder of a call future option has as an exercise price $40 for a particular future contract, and the current future price for the same underlying asset, expiration date, etc. is trading at $37, then the call future option holder can exercise their option for a cash settlement of $3.

### Types of Options/Futures Markets

Financial derivatives are traded in variety of organized settings in the United States. Primary markets are markets in which new issues of securities (including financial derivatives) are offered for sale to the public. This is usually done by investment banks, who underwrite the securities and act as brokers of the securities by seeking investors to whom the newly issued securities can be sold to. Secondary markets are general defined as markets in which previously sold securities are traded. By definition, trading that takes place in secondary markets does not affect the outstanding amount of a given security. There are two types of secondary markets on which options and futures are traded, formalized exchanges such as the Chicago Board of Options Exchange (CBOE) and the Chicago Board of Trade (CBOT), and informal exchanges. These informal exchanges are also known as over-the-counter exchanges, and are composed of informal networks of brokers and dealers who negotiate sales of specific securities. Customized options and futures that are not available on the formal exchanges are typically traded over-the-counter. In an extreme example, organized gambling and on-line betting systems would be a form of over-the-counter trading. All of the formalized exchanges on which options and futures are traded on jointly own an organization called the Option Clearing Corporation (OCC). The OCC is an entity which steps in between buys and sells of options and futures to guarantee contract performance on both sides. This is done to eliminate contract performance risk for buyers and sells. By eliminating contract performance risk, the exchanges greatly enhance investor confidence in the financial products sold and thereby increase overall market liquidity.

For futures (buyers and sellers) and option writers, the OCC requires traders to post a good faith deposit, called a margin, in order to guarantee contract performance. When an option could be exercised against its underlying assets current price for a profit, this is known as an “in the money” option. In the case of option writers, the margin amount is determined by the amount in which the options are in the money at any given time and the writer's assets in the account. If the option writer possesses the underlying assets on which the option is based (this is not always possible with options based on intangible assets such as indices), in the proper amount, then no changes to the margin amount need be made, as contract performance is always guaranteed. If the option writer does not possess the underlying assets and the option, initially or subsequent to expiration, moves into the money, then the option writer will receive a margin call to add assets to the account in order to continue to guarantee contract performance. Because the value of most underlying assets can change on a daily basis, the margin evaluation is conducted each day that the options are traded until the option is exercised or expires. This process is called marking to market.

For futures traders, the process of marking to market occurs for both buyers and sellers. At initial execution of a trader, each party establishes a margin account. In the case of futures, most margin account are established with cash or near-cash securities. The initial amount required for the margin account by the OCC depends on the type of future being traded and the historic volatility of the underlying assets. Like the margin accounts for option writers, a comparison is made each day that future contracts are traded. For both buyers and sellers of futures, the OCC requires that all positions recognize profits daily as they accrue. The process of marking to market for futures occurs by comparing the future price of the initial contract with the future price of contracts being entered into subsequently for the same underlying asset and maturity date. The difference between these prices is then added, or subtracted, to/from the traders margin account. This process is called marking to market. The sum of all the mark to market adjustments made over the course of the existence of the future contract must ultimately equal the difference between the initial future price and the final spot price on the day of expiration. Like option writers, if a future traders account falls below a certain level pre-determined by the OCC, then a margin call will occur, requiring the trader to add additional assets to their margin account in order to meet the margin requirement.

Be it options, futures, or other more esoteric financial derivatives, a set of variables exist which commonly describe these financial products.

The first is the underlying asset on which the derivative is based. Implicit in the selection of the underlying asset is how the value of the underlying asset is measured (e.g. price, quantity, etc.)

The second is the exercise price, which is based on the value, price, quantity, etc. of the underlying asset, is the value of the underlying asset at which the derivative can be acted upon (e.g. “exercised”), and is the variable that is compared to the current price of the underlying asset to determine the ultimate value of the derivative.

The third is the standard unit, which is the number of units of the underlying asset that each financial derivative represents.

A final variable is the time of expiration (or expiration date). This variable sets the time period at which the current price of the underlying asset will be evaluated and sets either the time period for execution of the derivative or puts an outer limit on the period of time in which the derivative financial product can be executed.

Regardless of the type of financial derivative, each of these variables is necessary in order to define the product. For example, a future contract on wheat has as its underlying asset wheat, a standard unit of 5000 bushels of wheat per contract, an expiration date of 3 months from the date of issue, and an exercise price corresponding to the agreed upon future price of wheat at the time the future was purchased. An example stock option would have as its underlying asset the common stock of IBM, a standard unit of 100 shares of IBM common stock, an expiration date of 3 months from the date of issue, and an exercise price as specified at the time the option was written. As a final example, an index option would have as its underlying asset the value of the S&P 500 index (an intangible asset), a standard unit of 100 units of the index value, an expiration date of 3 months from the date of issue, and an exercise price as specified at the time the option was written.

### General Description of the Structure U.S. Pharmaceutical Industry

The United States is by far the largest pharmaceutical market in the world. See e.g., B. Hirschler, “Global drug sales growth lowest in four years” (January 2003). As reported by IMS Health, pharmaceutical sales in the U.S. (year to date through November 2002) were $146 billion. This is over three times larger than the next largest pharmaceutical market, Japan. A variety of companies, both large and small, are involved in the discovery of pharmaceutical agents sold in the U.S. In general, the more productive research is conducted in smaller organizations. However, the development, marketing, and sales of pharmaceuticals in the U.S. is dominated by large pharmaceutical companies. The reason for this structure is based on barriers to entry and economies of scale. Unlike basic research, which often is most productive in small organizations, it takes vast organizations, capital, and regulatory knowledge to bring a pharmaceutical product to market in the U.S. Similarly, in order to effectively market a pharmaceutical product in the U.S. large sales forces and relationships with managed care organizations are required. Because of these hurdles, when small companies discovery promising pharmaceutical agents, they typically enter into licensing agreements with larger pharmaceutical companies who possess the necessary human and financial capital to develop and market the products. Between this phenomena and the products directly discovered and developed by large pharmaceutical companies, most major pharmaceutical products sales are represented, at least partially, in the income and balance sheet statements of a small number (e.g. approximately 15) of large companies.

Once a pharmaceutical product looses its patent exclusivity, usually one or more generic manufacturers will enter the marketplace with generic versions of the original, branded product. Because of strong price pressure and managed care control of reimbursed access to prescription medications, these generic products will quickly convert new and existing prescription volume of a given branded product. Within several months, the vast majority of the original branded prescription sales will be eliminated by this generic substitution process.

### General Description of Data Sources:

In the United States, prescription (Rx) drugs are generally defined as pharmaceutical agents that, because of the need to monitor side effects, abuse potential, etc. are managed as controlled substances. Therefore, a prescription pharmaceutical is any pharmaceutical agent that requires having a state licensed medical doctor or other authorized healthcare provider (depending on the appropriate state law) author a prescription for the product in order for a pharmacy or other legal drug distributor (such a mail order pharmacy distributor) to sell the pharmaceutical to a patient. This is in contrast to over-the-counter (OTC) pharmaceuticals, such as ibuprofen, which have been approved by the FDA for direct distribution to consumers without the need for a prescription.

When a patient “purchases” a pharmaceutical product from a pharmacy (either retail or mail order) utilizing a prescription, much is occurring behind the scenes during the transaction. Because of various state laws requiring prescriptions to be on the order of a physician or other healthcare provider, the pharmacy is required to track the prescription (which product, product strength, quantity, manufacturer, lot number, etc.) and by whom the prescription was authorized. This prescription tracking is almost always done electronically. Each unique product/strength combination of a pharmaceutical product is tracked via a unique National Drug Catalog (NDC) number. The prescription authorizer (i.e. prescriber) is usually tracked via a unique identification number such as a state medical license number, etc. Note that the prescription can be communicated to the pharmacy in various ways: via a traditional written prescription, via oral communication (by phone, etc.) or via various electronic methods. Additionally, if the prescription is being covered by some form of insurance, communication takes place at the pharmacy (again, almost always electronically) with the insurance provider, such as a Health Maintenance Organization (HMO), or its agent, such as a Pharmacy Benefits Manager (PBM), to determine if the pharmaceutical being requested is covered by the insurance provider, what co-pay is required of the patient, and, if the product is not covered by the insurance provider, what substitute product(s) are covered by the insurance provider. In summary, because of legal requirements, inventory tracking, and communication and payment verification with a third party payor, practically every prescription filled in the U.S. today is tracked electronically.

Because of its position as the focal point of pharmaceutical transactions, the prescription that is written by a physician, and the subsequent filling of that prescription with the requested amount of product, has become the de facto unit of measure for transaction volume in the pharmaceutical industry. At first blush this may seem a tenuous and variable unit of measure, as the physician could hypothetically request any quantity of product on a prescription. However, two forces work concurrently to standardize the volume typically requested and dispensed with a given prescription. First, the physician, desiring to monitor both the effect of a drug on the disease being treated and the development of any side effects that may results from taking the product, typically limits the amount of drug a patient can obtain at any one time (e.g. 1 month supply) and the number of times a patient can refill the prescription (e.g. 3 refills, etc.) In this way, the patient will need to visit with the physician again after a defined period of time (e.g. 3 months) before being able to obtain a new prescription and thus more of the pharmaceutical agent. At this follow-up visit the physician can monitor the efficacy of a drug therapy and the development of any associated side effects. If the physician determines the patient should continue on the product, a new prescription with a defined number of refills will be provided. Note that the first time product is dispensed to a patient on a prescription is known as a new prescription (NRx). NRxs tracked separately from refills dispensed on the same prescription. The sum of new prescriptions (NRxs) and refill prescriptions is known as total prescriptions (TRxs).

The second force working to standardize the amount filled on a prescription comes from insurance providers. Insurance providers have a financial incentive to limit the amount of pharmaceutical product a patient can obtain for a given prescription. The insurance provider pays for pharmaceutical product(s) on a unit volume basis (pills, tablets, milliliters, etc.) whereas patient co-pays occur on a prescription basis. Therefore, the more product requested on a prescription, the lower the percentage of the cost burden being borne by the patient. These two forces have resulted in the convergence of an industry standard one (1) month supply per prescription fill. Note that this is for the general case of routinely administered medications for chronic conditions, such as high blood pressure, distributed through a retail pharmacy. For medications used to treat acute conditions, such as an oral antibiotic, a prescription represents one (1) course of therapy. This one (1) month supply of therapy per prescription standard also does not necessarily apply to chronic medications filled through a mail order pharmacy, as mail order pharmacies often distribute multiple fills of a prescription at once.

The large volume and price premiums enjoyed by the pharmaceutical industry in the U.S. market, along with the detailed electronic tracking mechanisms described above, have combined to create a huge demand for detailed pharmaceutical sales performance information. This demand has resulted in the evolution of an entire industry devoted to supplying robust, sophisticated and timely pharmaceutical prescription information to the pharmaceutical industry and related industries (market research firms, Wall Street analysts, etc.) The pharmaceutical industry in the United States enjoys availability of transaction information regarding product performance that is second only to the financial industry in its level of robustness, timeliness, and detail. Though a variety of companies are involved in the pharmaceutical information business, the two leading suppliers of prescription information in the industry are IMS America (New York Stock Exchange ticker symbol Rx) and NDCHealth (New York Stock Exchange ticker symbol NDC).

Data providers, such as IMS and NDCHealth, obtain transaction level prescription data from pharmacies and mail order pharmacies, either from directly purchasing the data or via discounting the price on a service provided to the pharmacy. These organizations then verify the data and apply various statistical projection methodologies (to account for data gaps, such as those caused by pharmacy chains who refuse to sell their pharmacy data) to result in robust, projected national prescription volume data for any given prescription pharmaceutical product or any combination thereof, and for almost any desired time period (e.g. for one day, for the week ending Dec. 27, 2002, for the month of August 2002, for the year 1999, etc.). Because pharmacies also track a unique prescriber number associated with each prescription, these data providers can report prescription data, by product and strength, at the individual physician level or, by associating an office location for each prescriber, at any level of geographic summary (e.g. prescription volume in the state of New Jersey, in zip code 46514, etc.)

For products dispensed directly to a patient by a healthcare provider (such as an intravenous (IV) antibiotic being used in a hospital emergency room) and thus not tracked by a prescription, the data providers have developed methods to track sales of these products via purchasing data from pharmaceutical wholesalers and pharmaceutical manufacturers. The wholesalers and manufacturers provide data on the number of units shipped to direct purchasers of products (e.g. hospitals, long-term care facilities, etc.). The data providers then aggregate this data. In the case of products solely being administered to patient directly by a healthcare provider (e.g. an IV antibiotic), the national data and sub-sets thereof (e.g. down to an individual hospital or other purchaser) is typically reported in numbers of individual administered units or a dollarized versus thereof. A dollarized unit volume is defined as the unit volume multiplied by some standard cost per unit. Because of the lack of real-time tracking mechanisms, bulk purchasing from wholesalers by end-users, etc., data for these types of products is not available to the level of time granularity that is seen with other prescription medications (e.g. perhaps only being available on a monthly basis).

Prescription data for a given pharmaceutical product is most often reported in two different ways, as a new prescription (NRx) or as a total prescription (TRx). As discussed previously, the first time product is dispensed to a patient on a prescription it is counted as a new prescription (NRx). After a patient has exhausted the refills on their current prescription and a new one is issued by a physician, the first filling on the new prescription will again be counted as a new prescription. Refills dispensed on prescriptions are tracked separately as refill prescriptions, which we will call RRx's, though these are typically not reported. The sum of new prescriptions (NRx's) and refill prescriptions (RRx's) is known as total prescriptions (TRx's). For example if a patient received three (3) prescriptions during a given year, each with four (4) total fills available, and filled all the refills, that patient would represent three (3) NRx's, nine (9) RRx's, and twelve (12) TRx's. Therefore, total prescriptions (TRx's) will closely track the overall unit sales of a pharmaceutical product, while new prescriptions (NRx's), at least for medications treating chronic diseases, are somewhat of a leading indicator of TRx's. In the case of medicines treating acute conditions (e.g. oral antibiotics), NRx volume and TRx volume may be nearly identical. For medicines treating chronic conditions, the ratio of NRx's to TRx's can also indicative of the relative market maturity of a product or group of products, as new products being rapidly adopted will have a large portion of their TRx volume originating from NRx's, while a more mature product may already have a large established base of patients on treatment, and therefore NRx volume will represent less of the overall TRx volume of the product. Though not currently reported, other types of prescription counts can be imagined, such as new to product prescriptions (NPRx), in which only the first prescription for a product given to a patient is recorded.

For purpose of the present invention, the term prescription volume shall include any measure of prescriptions including NRx, TRx, RRx, NPRx, and any related prescription subsets or derivatives thereof.

Measures of gross sales for pharmaceutical products are also available and reported by various data providers. However, these sales are often self reported by pharmaceutical companies and are typically not available in time increments less that once (1) month. Additionally, the frequent, and often substantial, discounting in the pharmaceutical industry makes these gross sales numbers a much more subjective measure of product performance than prescription volume. As such, these measures, in their current state of reporting, would not be well suited to be utilized as objective measures of individual pharmaceutical product performance.

For data collection, analysis and verification reasons, prescription volume, sales, and unit measures are typically reported with some level of time delay (e.g. data for the week ending Dec. 27, 2002 is available 6 days later, etc.).

For purposes of the present invention, a performance indicator for a prescription pharmaceutical product is defined to include the direct prescription or unit sales volume of a particular pharmaceutical product, or group of products, or a derivative thereof (such as market share, ratios of prescription volume to historic comparables, dollarized prescription volume, average number of prescriptions, etc.) for a given time period.

### BRIEF DESCRIPTION OF DRAWINGS

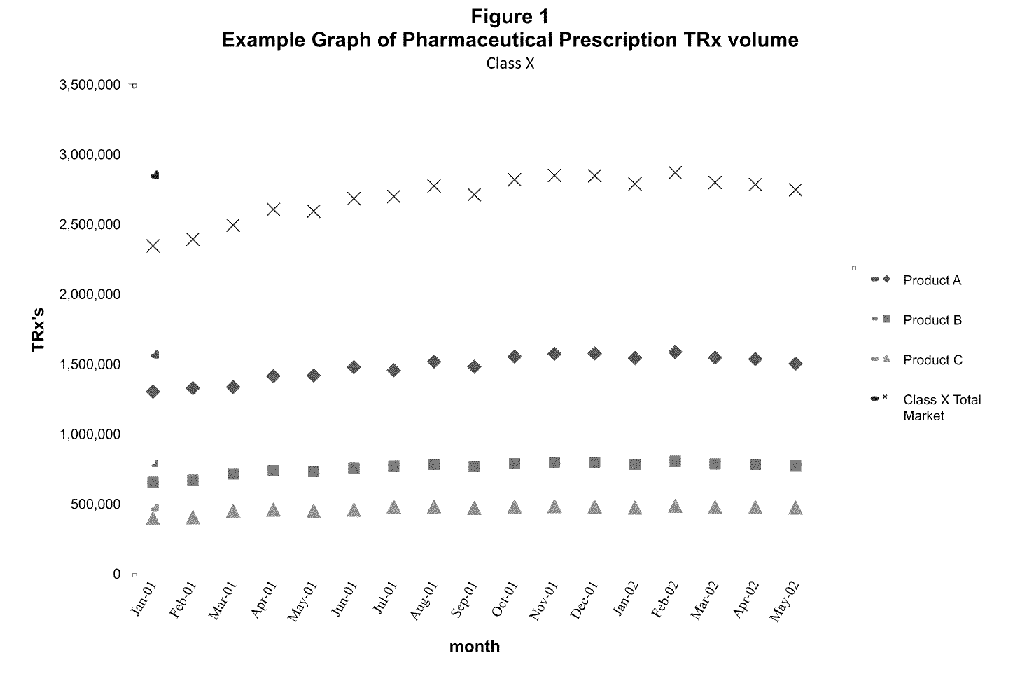

Prescription data for individual products are then usually aggregated together with products with similar mechanisms of action or that treat the same disease. This is done to define a market of comparison for pharmaceutical products. A hypothetical example of the reporting of prescription data for a given pharmaceutical product is given in FIG. 1. FIG. 1 displays, as a line graph, the monthly TRx volume for three (3) individual products and a total TRx line which is the sum of the TRx volume for the three (3) products in this market. The graph shows 17 months of data. Much can be gleaned from such a representation. First, assuming the three products are the only products currently used to treat a given disease, we can see that product A is clearly the market leader. For example, in the month of May 2002, product A recorded 1,500,000 TRx's versus the total market for class X of 2,742,000 for the same month. Therefore, for the month of May 2002, product A had a TRx market share of 54.7%. This type of display of individual product performance along with similar products and a defined market total is very common. To compare the relative commercial performance of a particular pharmaceutical, data providers often group a given product together with other products used to treat the same disease or that operate via the same biological mechanisms of action. The grouping, over time, results in generally accepted market definitions.

Similar displays can be utilized for other prescription volume measures related measures (unit sales, gross sales, etc.)

### DETAILED DESCRIPTION

### Problems in Related Art

Current financial instruments (stocks, bonds, options, futures, other derivatives, etc.) related to the pharmaceutical industry represent aggregated performance of several, often large, pharmaceutical product franchises. Unfortunately, this aggregation does not allow for a good measure of individual product performance. Additionally, in the current state of financial services, investors who are bullish/bearish on the prospects of a particular company's product may act on those beliefs only indirectly via the purchase of stock of the company or option/futures of that stock.

### Summary of Invention

The present invention describes the creation of financial products such as options, futures, and other derivatives whereby the underlying asset of the derivative is based on a performance indicator, such as prescription volume or prescription market share, of one or more pharmaceutical product(s). There is currently no financial product or service that allows an investor to take an undiluted position in the performance of an individual pharmaceutical product. This problem is not unique to the pharmaceutical industry. However, unlike other industries, the existence of: 1) robust, nearly continuous, projected national prescription volume data for any given prescription pharmaceutical product or any combination thereof; 2) robust, standardized futures and options markets; and 3) the success of options and futures based on intangible assets, can all be combined to address this problem.

### Benefits of Invention

The current financial system provides only indirect ways for investors to take positions in the prospects of specific U.S. pharmaceutical product. As discussed previously, most major pharmaceutical products are partially or wholly owned by large pharmaceutical companies whose total sales are composed of multiple products. Therefore, taking a stock or derivative position in a pharmaceutical company because of an interest in the success or failure of one particular product is, at best, an imperfect way to capitalize directly on that interest.

The present invention describes the creation of financial products based on existing standardized, continuous, rigorous, and widely available data sources specific to a particular pharmaceutical product or group of products that allows investors to take financial positions that are directly related to the performance of a given product or groups of products. Additionally, there are a variety of organizations (HMO's, pharmaceutical wholesalers) that can utilize the pharmaceutical derivative financial products to hedge risks in their on-going operations.

The manner in which these pharmaceutical derivative financial products are constructed is very similar to that of derivative financial products based on stock market indices. As previously described, financial derivatives can be defined by a set of common variables. The first is the underlying asset on which the derivative is based. The second is the exercise price, which is based on the value, price, quantity, etc. of the underlying asset. The third is a standard unit, which is the number of units of the underlying asset that each financial derivative represents. A final variable is the time of expiration (or expiration date). This variable puts an outer limit on the period of time in which the derivative financial product can be executed. Regardless of the type of financial derivative, each of these variables is necessary in order to define the product.

In the case of the present invention, the underlying asset, like that of an index option or future, is based on an intangible asset. In this case, the intangible asset is some form of a performance indicator for a pharmaceutical product or group of products. Like an index option or index future, the exercise price is also based on the same intangible asset. For the determination of the standard unit, different approaches are required for large numerical value performance indicators such as direct prescription volume or dollarized prescription volume vs. small numerical value performance indicators such as market share. In pharmaceutical derivatives based on small numerical value performance indicators such as market share, there is a natural limit to the magnitude of the value of the underlying asset (e.g. between 0 and 100 for market share, etc.). Since the magnitude of the market share denomination is similar to that of many stock prices, the typical standard unit of 100 for stock options could be used. For prescription volume ratio based derivatives, where the exercise price is based on the ratio of the prescription volume for a given period to some prior period (previous month, same period previous year, etc.), the ratio is likely to be a small value (e.g. between zero and 2) and so therefore a larger standard unit value could be utilized (e.g. 1000). For pharmaceutical derivatives based on large numerical value descriptions (which are typically cumulative in nature) such as direct prescription volume, in which the underlying asset will have larger magnitudes (e.g. millions of prescriptions per month, etc.) a standard unit of 1/1000 can be utilized in order to maintain reasonable potential valuation levels. Note that these standard unit values are arbitrary, could be structured in any number of ways, and must ultimately be interchangeable. For example, an investor who holds 1000 options with a standard unit of 1/100 has the same amount of financial exposure to the underlying asset of the option as if they held 10 options with a standard unit of 1 (assuming the same underlying asset, time of expiration, etc.). Therefore, the process and reasoning behind deciding an appropriate standard unit is similar to that made by public companies when pricing their initial public offering or doing a stock split, which centers on maintaining market liquidity. Though important to maintaining market liquidity of the assets, standard units have little impact on the function of financial derivatives in general or on the pharmaceutical derivatives described herein. For the time of expiration, any value more than 1 day greater than the date of issue could theoretically utilized, though in practice values>=1 month from the date of issue of the pharmaceutical derivative would be more practical and consistent with current financial derivative trading. Unlike most existing options and futures, pharmaceutical derivative financial products are a measure of performance over a given period of time. As such, implicit in the time of expiration is the beginning of the time period being measured (e.g. prescription volume for the three months ending Mar. 31, 2003, etc.)

The process of marking to market for pharmaceutical derivative financial products could be similar to financial derivatives based on intangible assets. For a future, regardless of how it is related to the underlying asset, the trader's position could be marked to market on a daily basis against the futures price for the given contract at the end of the day. This is similar to the current method used for futures trading.

For options, actual volume based performance indicators are cumulative in nature and would be difficult to mark to market. Therefore, a system would need to be established whereby some measure available on an interim basis (daily or weekly market share, ratios of prescription volume to historic comparables, average number of prescriptions for a given time period) would be utilized for marking to market purposes. For options whose underlying asset is based on derivatives of prescription volume (such as the market share, ratios of prescription volume to historic comparables, average number of prescriptions for a given time period, etc.), the options could be marked to market directly against the values calculated for an interim period.

Because interim performance indicators for pharmaceutical products, such as daily or weekly NRx market share, etc., are potentially more volatile that the longer time horizon measures such as monthly NRx market share, rules would need to be established regarding how American style options (e.g. can be exercised anytime up to an including the time of expiration) would be managed and against what interim data points this would occur.

The process of managing pharmaceutical derivative financial products for standardized exchange trading would require a joint effort between an organization like the OCC and a standardized data provider (IMS, NDCHealth, etc.) in order to set rules regarding a variety of issues including:
How to handle new products being introduced to the market. A suggested method would be to have a standardized procedure to announce what market a new product would be defined in at the time of a formal, public filing with the Food and Drug Administration (FDA). This could occur when a product is filed via a New Drug Application (NDA), an Investigational New Drug (IND) application, or similar formal regulatory approval filing.
Standardized de-listing rules would need to be created to manage the life cycle of products (e.g. products under 3% market share or below a certain prescription volume would not longer be traded).
Because pharmaceutical performance data has a time lag associated with its availability, a standard set of timing of maturity of financial derivatives would need to be established (e.g. Options would expire at a set date such as the 2^{nd} Friday after end of month with settlement based on monthly data, etc.)
Occasionally, revisions of historic prescription data occur. Rules regarding how to handle these revisions would need to be established (e.g. later revisions of market share ignored, etc.)
Rule regarding naming of the pharmaceutical derivative financial products. The opportunity exists to incorporate the underlying brand name of the pharmaceutical products whose exercise price it is based on.
Rules regarding exercise price intervals, minimum tick sizes, etc. would be required.

### PREFERRED EMBODIMENTS

### Example 1

An example of a preferred embodiment of the invention would be an option whose underlying asset is the total prescription volume of the cholesterol lowering drug Lipitor®. In the fall of 2002, a competitor to Lipitor® was expected to be formally approved by the FDA and launched in the U.S., product X. Product X is expected to be commercially available Nov. 25, 2002. An investor, investor A, was very concerned about the impact product X was going to have on the prescription volume and market share of Lipitor®. Investor A purchases one put option on Lipitor®, which expires Jan. 31, 2003, with an exercise price set to 1,500,000 TRx's. The standard unit of the Lipitor® TRx put option is 1/100. If product X, or some other factor, reduces the volume of Lipitor® used in January 2003 to 1,400,000, then investor A will be able to exercise his option. The payoff will be equal to the difference between the exercise price of the option (1,500,000) and the actual TRx prescribe volume (1,400,000), or 100,000 times the standard unit of 1/100, or $1000 per contract.

### Example 2

A second example would be an option whose underlying asset is the NRx prescription market share of the cholesterol lowering drug Lipitor®. In the fall of 2002, a competitor to Lipitor was expected to be formally approved by the FDA and launched in the U.S., product X. It was determined at the time of its Ivestigational New Drug (IND) filing with the FDA that product X would be included in the same market definition as Lipitor®. Product X is expected to be commercially available Nov. 25, 2002. An investor, investor B, is bearish on the prospects of product X, and does not think it will have a dramatic impact on the NRx market share of Lipitor®. Investor B purchases one call option on the market share for Lipitor® for the month of January 2003 with an exercise price set to a NRx percentage market share for Lipitor® of 45%. The standard unit of the Lipitor® NRx call option is 100. Because product X ends up being delayed in its final approval, Lipitor®'s final NRx market share for the month of January 2003 ends up being 50%. Investor B would then be able to exercises his call option and receive a cash payment of the 5 percentage point difference between the exercise price and the actual market share value for Lipitor® for the month of January 2003, times the standard unit of 100, or $500 per contract.

### Example 3

A third example of an application of the present invention would be a future whose underlying asset is the total prescription volume of the cholesterol lowering drug Lipitor®. In the fall of 2002, a competitor to Lipitor® was expected to be formally approved by the FDA and launched in the U.S., product X. Product X is expected to be commercially available Nov. 25, 2002. An investor, investor A, was very concerned about the impact product X was going to have on the prescription volume and market share of Lipitor®. Investor A sells one future contract on Lipitor®, which expires January 31, 2003, with an exercise price set to 1,500,000 TRx's. The standard unit of the Lipitor® TRx future has is 1/100. Because of product X, or some other factor, the actual volume of Lipitor® used in January 2003 ends up being 1,400,000. At this time, the purchaser of the Lipitor® future contract would be required to “take delivery” of the future contract from investor A. The settlement of the future contract would be conducted as a payoff, which would be equal to the difference between the exercise price of the future (1,500,000) and the actual TRx prescribe volume (1,400,000), or 100,000 times the contract multiplier of 1/100, or $1000 per contract. Therefore, the seller of the contract, or the short position on the contract (investor A) would be entitled to $1000 from the purchaser of the Lipitor® TRx future contract.

### Example 4

A fourth example of an application of the present invention would be an option based on the total prescription volume of the cholesterol lowering drug Lipitor®. In the fall of 2002, a pharmaceutical wholesaler takes advantage of a discount offered by the manufacturer of Lipitor®, Pfizer Incorporated, and purchases a large quantity of Lipitor® for its inventory. The wholesaler purchased this volume of Lipitor® based on the assumption that prescription demand for Lipitor® would average 1,500,000 TRx's for the first 3 months of 2003, and wishes to hedge its position of Lipitor® inventory. The wholesaler purchases 100 put options on Lipitor®, which expires Mar. 31, 2003, with an exercise price set to 4,500,000 TRx's for the three month period Jan. 1-Mar. 31, 2003. The standard unit of the Lipitor® TRx future is 1/100. At the end of the period, the actual TRx volume of Lipitor® ends up being 4,200,000. Because of the low actual demand, the wholesaler ending up not being able to sell as much Lipitor® as originally forecasted, and thus has lost money by carrying excess Lipitor® inventory. However, the hedge taken by purchasing the put options on Lipitor® has worked. At the time of expiration, the wholesaler can exercise its put options. The settlement of each put option would be conducted as a cash payoff, which would be equal to the difference between the exercise price of the option (4,500,000) and the actual TRx prescribe volume (4,200,000), or 300,000 times the contract multiplier of 1/100, or $3000 per option. Therefore, the writer of the put option would be required to pay $3000 to the wholesaler for each option, or $300,000 total.

### Note on Scope of Invention

The above are descriptions and preferred embodiments are examples only and are in no way intended to limit the potential combinations under which the present invention could be utilized.

There are an unlimited number of ways the underlying asset of a pharmaceutical derivative product can be based on a products' prescription volume or a derivation thereof. The description and examples provided in the current application are for illustrative purposes only, and in no way limit the scope of the present invention.

Note also that the idea of constructing financial products where the value of the product is related to performance indicators for pharmaceutical products can be applied beyond the scope of the present invention to include tracking stocks and other sub-divided equity products such as dividend equity strips described by Whitworth in US Application 2002/0161684.

1. A method implemented at least partially in a programmed computer for offering for sale a derivative financial product, the method comprising: creating, by said computer a derivative financial product wherein the said derivative financial product has an underlying asset based on a prescription market share of a pharmaceutical product, an exercise price based on said underlying asset wherein the exercise price is within the range of 0 to 100, a standard unit for said underlying asset wherein the standard unit is within the range of 0 to 1000, and a time of expiration for a combination of said underlying asset, said standard unit and said exercise price wherein the time of expiration is within the range of 1 month to 5 years from a date of issue of said derivative financial product; selling said derivative financial product to a buyer.

2. A method implemented at least partially in a programmed computer for offering for sale a derivative financial product, the method comprising: creating, by said computer a derivative financial product wherein the said derivative financial product has an underlying asset based on a unit volume of a pharmaceutical product, an exercise price based on said underlying asset wherein the exercise price is within the range of 0 to 1 billion, a standard unit for said underlying asset wherein the standard unit is within the range of 0 to 1 million, and a time of expiration for a combination of said underlying asset, said standard unit and said exercise price wherein the time of expiration is within the range of 1 month to 5 years from a date of issue of said derivative financial product; selling said derivative financial product to a buyer.

3. A method implemented at least partially in a programmed computer for offering for sale a derivative financial product, the method comprising: creating, by said computer a derivative financial product wherein the said derivative financial product has an underlying asset based on a prescription volume of a pharmaceutical product, an exercise price based on said underlying asset wherein the exercise price is within the range of 0 to 1 billion, a standard unit for said underlying asset wherein the standard unit is within the range of 0 to 1 million, and a time of expiration for a combination of said underlying asset, said standard unit and said exercise price wherein the time of expiration is within the range of 1 month to 5 years from a date of issue of said derivative financial product; selling said derivative financial product to a buyer.

4. A method according to claim 2, wherein the volume of the pharmaceutical product is the dollarized prescription or dollarized unit volume of one or more pharmaceutical product(s).

5. A method according to claim 3, wherein the volume of the pharmaceutical product is the dollarized prescription or dollarized unit volume of one or more pharmaceutical product(s).

6. A method according to claim 2, wherein the volume of the pharmaceutical product is the average prescription or average unit volume for a given time period of one or more pharmaceutical product(s).

7. A method according to claim 3, wherein the volume of the pharmaceutical product is the average prescription or average unit volume for a given time period of one or more pharmaceutical product(s).

8. A method according to claim 2, wherein the volume of the pharmaceutical product is a ratio of prescription or unit volume to historic comparables of one or more pharmaceutical product(s).

9. A method according to claim 3, wherein the volume of the pharmaceutical product is a ratio of prescription or unit volume to historic comparables of one or more pharmaceutical product(s).
